(19) United States
(12) Patent Application Publication
(10) Pub. No.: US 2011/0294547 A1
(43) Pub. Date: Dec. 1, 2011

(54) METHOD AND SYSTEM FOR INTERACTIVE OPERATION BETWEEN MOBILE PHONE AND PC BASED ON A MIDDLEWARE

(75) Inventor: Xianle Ni, Beijing (CN)

(73) Assignee: NETQIN MOBILE (BEIJING) TECHNOLOGY CO., LTD., Haidian District, Beijing (CN)

(21) Appl. No.: 13/128,371

(22) PCT Filed: Nov. 11, 2008
(86) PCT No.: PCT/CN2008/073003

§ 371 Date: Jul. 12, 2011

(51) Int. Cl. H04W 88/02

(52) U.S. Cl. 455/557

(57) ABSTRACT

A system for interactive operation between mobile phone and PC based on a middleware is provided, which includes: a mobile phone upon which is installed an interactive operation agent; a PC which is installed an interactive operation system, wherein the interactive operation system includes: a user operation interface module, a interactive operation middleware, an adapting converting module, an online communication module and a drive program module; a server, which includes: a drive program library, a content database, a content adapting module and an online communication module; a physical connection is established between the mobile phone and the PC, a physical connection is established between the PC and the server. In addition, a method for interactive operation between mobile phone and PC based on a middleware is provided. Firstly, a connection is established between the mobile phone and the PC successfully; then users can choose to perform the following four operations: importing appropriate content to the mobile phone via the server; automatically converting PC/internet content and transmitting it to the mobile phone; adapting and sharing content between mobile phones; performing such operations as data backup, address list synchronization, schedule synchronization and so on.

### BACKGROUND OF INVENTION

1. Field of the Invention

The present invention relates to the technical field of electronic communication and information exchange, particularly to a method and a system for interoperation between a mobile phone and a PC based on a middleware.

2. Background Art

Three interrelated arts, Computer, Communication and Consumer-electronics, collectively referred to as 3C technology, are important technical areas that continuously improve people's living quality. Currently, there is a trend of more integrated, smaller in sizes, and multifunction in the above areas, of which mobile phone is an important product.

The earliest mobile phones were used for wireless communication only, and with the continuous development of mobile phone features, they have become an important electronic tool that integrates various functions, such as communication, recreation, and data processing. Therefore, it is an urgent need to connect the mobile phone with the PC for interoperation.

At present, most mobile phone manufacturers provide connection suite to connect the mobile phone with PC for operation: synchronizing contacts, agenda, favorites, data backup, etc.. However, the mobile models are so various now that there is no uniform standard system for PC connection. As different phone models need their own connection suites by different manufacturers, the users have to search for the right connection suites to download and install for use, which causes inconvenience for operations of common users.

Additionally, with the development of mobile technology, more and more mobile applications developed for mobile phones, such as music player, video player, e-books, picture browser, etc.. However, these contents (including video, audio, pictures, e-books, software, etc.) suitable for mobile phones are not so rich. At present, there are abundant contents on PC or on the internet, but a large part of them are incompatible with the mobile phone (for example, the image resolution is too high, or the video encoding format is unsupportable, etc.), and they can be used on the mobile phones only after format conversion. Besides, content on different phone models can be shared only after format conversion due to incompatibility. However, it's very hard for common users to master the process of format conversion, because it requires specialized tools and comprises extremely complex steps, or even when the users have mastered it, they seldom use it due to its complexity.

Middleware, as a well-known technical means in the industry, is used between operating system software and application software normally for interconnection and interoperation between different platforms.

Agent is another well-known technical means in the industry, which is usually deployed on a particular device to receive requests from other devices and perform the task as required.

### SUMMARY OF INVENTION

In order to solve the above problem, the present invention provides a method and a system for interoperation that are based on a middleware and can shield hardware difference between different mobile phones by installing an interoperation system to auto identify the model of the phone and connect it to PC with the right driver automatically. Moreover, the present invention is able to provide via the server contents adaptive to the mobile phone, and with the feature of automatic format conversion, it is further able to convert contents on the PC or the internet into contents adaptive to the mobile phone and then transmit them to the mobile phone, and allow contents to be shared between different mobile phone models, which saves users the trouble of manual operation and enriches contents available to the phone to better satisfy users' demand.

According to the first aspect of the present invention, a system for interoperation between the mobile phone(s) and the PC(s) based on a middleware comprises: a mobile phone upon which is installed an interoperation agent; a PC upon which is installed an interoperation system, wherein the interoperation system includes: a user operation interface module, an interoperation middleware, an adaptive converter module and a driver module; wherein the mobile phone and the PC are physically connected.

Further, the system for interoperation between the mobile phone and PC based on a middleware may also comprise a server, which includes a driver library, a content database, a content adapter module and a network communication module; the PC installed with the interoperation system further includes a network communication module; wherein the PC is physically connected to the server.

Optionally, the mobile phone is connected to the PC by Bluetooth, infrared, the data cable or WLAN. Optionally, the PC and the server are connected via the internet.

According to the second aspect of the present invention, a method for interoperation between the mobile phone(s) and the PC(s) based on a middleware comprises the following steps: the mobile phone is physically connected to the PC; the interoperation system automatically detects the model of the mobile phone that is connected to the PC; the interoperation system searches in the local driver module for a driver suitable for said model; when such a driver is searched out, install it directly for use; when such driver is not available, the interoperation system is connected to the server via the internet, searches a suitable driver, downloads it to local system and installs it for use; the PC and the mobile phone are connected successfully. Optionally, there is a prompt for the user on the PC after the PC is successfully connected to the mobile phone.

According to the second aspect of the present invention, the method further comprises the following steps after the PC is successfully connected to the mobile phone: the interoperation system communicates with the server via the internet, acquires the content list adaptive to the connected mobile phone and displays it to the user; the user requests to acquire the contents of interest in the content list; the interoperation system communicates with the server and requests to download said contents on behalf of the user and transmit the downloaded contents to the mobile phone.

According to the second aspect of the present invention, the method further comprises the following steps after the PC is successfully connected to the mobile phone: the user selects contents of interest from the file browser on the PC and then requests to transmit said contents to the mobile phone; implements the adaptation process of the mobile phone contents, and converts said contents into contents adaptive to the connected mobile phone; the interoperation system communicates with the mobile phone and transmits the converted contents into the mobile phone.

According to the second aspect of the present invention, the method further comprises the following steps after the PC is successfully connected to the mobile phone: the user selects contents of interest from the Web browser on the PC and then requests to transmit said contents to the mobile phone; the interoperation system downloads said contents to the PC; implements the adaptation process of the mobile phone contents and converts said contents into contents adaptive to the connected mobile phone; the interoperation system communicates with the mobile phone and transmits the converted contents to the mobile phone.

According to the second aspect of the present invention, said adaptation process of the mobile phone contents further comprises the following steps: determining whether the interoperation system is able to complete content adaptation; if it is able to do so, the interoperation system completes content adaptation locally; if it is unable to do so, the interoperation system uploads the contents to be adapted to the server, and the server adapts the mobile phone contents and then transmits the adapted contents back to the interoperation system.

According to the second aspect of the present invention, the user makes a request using key combination or the shortcut of a certain item in the left or right click menu of the mouse.

The third aspect of the present invention relates to a method for interoperation between the mobile phones and PC(s) based on a middleware comprising the following steps: respectively connect the first mobile phone and the second mobile phone to the PC physically; the interoperation system automatically detects the model of the first mobile phone and the second mobile phone connected to the PC; the interoperation system searches in the local driver module for a driver suitable for the model of the first mobile phone and the second mobile phone; when such drivers of the first mobile phone and the second mobile phone are searched out, install them directly for use; when the driver of the first mobile phone or the second mobile phone is not available, the interoperation system is connected to the server via the internet, searches the suitable driver(s), downloads it to local system and installs it for use; the PC and the mobile phone are connected successfully.

According to the third aspect of the present invention, the method further comprises the following steps after the first mobile phone and the second mobile phone are successfully connected to the PC: the user selects contents of interest on the second mobile phone from the browser and then requests to transmit said contents to the first mobile phone; the interoperation system downloads said contents from the second mobile phone to the PC; implements the adaptation process of the mobile phone contents and converts said contents into contents adaptive to the first mobile phone; the interoperation system communicates with the first mobile phone and transmits the converted contents into the first mobile phone.

According to the third aspect of the present invention, the user makes a request using key combination or the shortcut of a certain item in the left or right click menu of the mouse.

According to the third aspect of the present invention, said adaptation process of the mobile phone contents further comprises the following steps: determining whether the interoperation system is able to complete content adaptation; when it is able to do so, the interoperation system completes content adaptation locally; when it is unable to do so, the interoperation system uploads the contents to be adapted to the server, and the server adapts the contents and then transmits the adapted contents to the interoperation system.

The fourth aspect of the present invention relates to a method for interoperation between a mobile phones and a PCs based on a middleware comprising the following steps: connecting the first mobile phone to the first PC physically, and connecting the second mobile phone to the second PC physically; the first interoperation system on the first PC automatically detects the model of the first mobile phone connected to the first PC, and the second interoperation system on the second PC automatically detects the model of the second mobile phone connected to the second PC; the first interoperation system searches in the local driver module for a driver suitable for the model of the first mobile phone and the second interoperation system searches in the local driver module for a driver suitable for the model of the second mobile phone; when there are such drivers of the first mobile phone and the second mobile phone, install them directly for use; when there are no such drivers of the first mobile phone or the second mobile phone available, the first interoperation system or the second interoperation system is connected to the server via the internet, searches suitable drivers, downloads them to the local system and installs them for use; the first PC and the first mobile phone are connected successfully, and the second PC and the second mobile phone are connected successfully.

According to the fourth aspect of the present invention, the method further comprises the following steps after the first PC is successfully connected to the first mobile phone and the second PC is successfully connected to the second mobile phone: the second user requests to upload contents of interest on the second mobile phone to the server; the second interoperation system which is successfully connected to the second mobile phone uploads said contents from the second mobile phone to the server; the first user requests to transmit said contents to the first mobile phone; the first interoperation system which is successfully connected to the first mobile phone informs the server of the model of the first mobile phone, the content adapter module of the server implements the adaptation process of the mobile phone contents, and the first interoperation system downloads contents adapted by the server; the first interoperation system which is successfully connected to the first mobile phone communicates with the first mobile phone and transmits the adapted contents to the first mobile phone.

According to the fourth aspect of the present invention, the method further comprises the following steps after the first PC is successfully connected to the first mobile phone and the second PC is successfully connected to the second mobile phone: the second user requests to upload contents of interest on the second mobile phone to the server; the second interoperation system which is successfully connected to the second mobile phone uploads said contents from the second mobile phone to the server; the first user requests to transmit said contents to the first mobile phone; the first interoperation system which is successfully connected to the first mobile phone downloads said contents from the server and implements the adaptation process of the mobile phone contents based on the model of the first mobile phone; the first interoperation system which is successfully connected to the first mobile phone communicates with the first mobile phone and transmits the adapted contents to the first mobile phone.

Optionally, the first mobile phone and the second mobile phone may be of different models.

The system and method for interoperation between a mobile phone and a PC based on a middleware have prominent advantages and effects compared with the prior art:
automatically identifying the model of the mobile phone and selecting the suitable driver after the mobile phone and the PC are connected physically, shielding hardware difference between different models to save the user the trouble of manual operation;
providing better user experience in that the unified operation interface allows the user to be familiar enough with the system even when different models of mobile phone are connected to the PC;
facilitating interoperation between the mobile phone and the PC, such as synchronizing contacts and agenda, contact backup, etc.; furthermore, the user can download contents of interest recommended by the server easily;
enriching contents on the mobile phone and simplifying user operation by auto adapting the contents on the PC/internet into contents adaptive to the mobile phone of particular model and transmit them to the mobile phone;
automatically adapting and sharing contents between different models of mobile phone according to the system and method of the invention.

It should be noted that the above general description and the detailed description below only serve as examples and explanations rather than limit the invention claimed hereby.

### BRIEF DESCRIPTION OF DRAWINGS

The figures provide better understanding of the features and advantages of the present invention when taken in conjunction with reading the description, wherein:

FIG. 1A illustrates an indicative structure of the system for interoperation between the mobile phone and the PC based on a middleware;

FIG. 1B illustrates another indicative structure for the system for interoperation between the mobile phone and the PC based on a middleware;

FIG. 2 illustrates the whole process of the present invention;

FIG. 3 illustrates the operation process of establishing connection between the PC and the mobile phone;

FIG. 4 illustrates the process of acquiring mobile phone contents from the server;

FIG. 5 illustrates the process in which the interoperation system automatically converts the contents on the PC and transmits them to the mobile phone;

FIG. 6 illustrates the process in which the interoperation system auto downloads and converts the contents on the internet and transmits them to mobile phone;

FIG. 7 illustrates the process of content adaptation and sharing between different mobile phones via the interoperation system;

FIG. 8 illustrates the process of content adaptation and sharing between different mobile phones via the server;

FIG. 9 illustrates the process of mobile phone content adaptation.

### DETAILED DESCRIPTION

Here below are some of the embodiments for carrying out the invention for basic understanding of the invention, and the embodiments are not intended to identify the critical or decisive factors of the invention or limit the scope of protection.

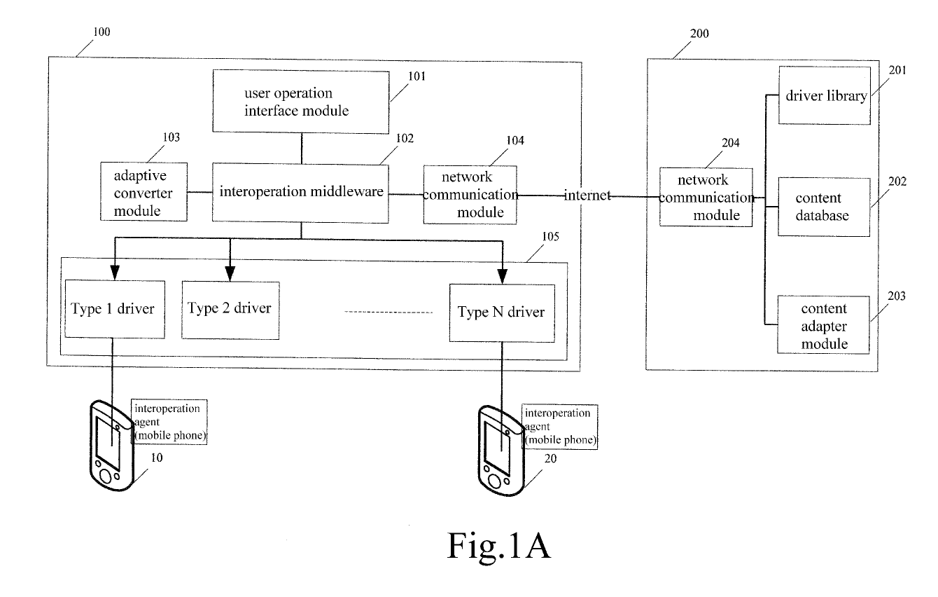

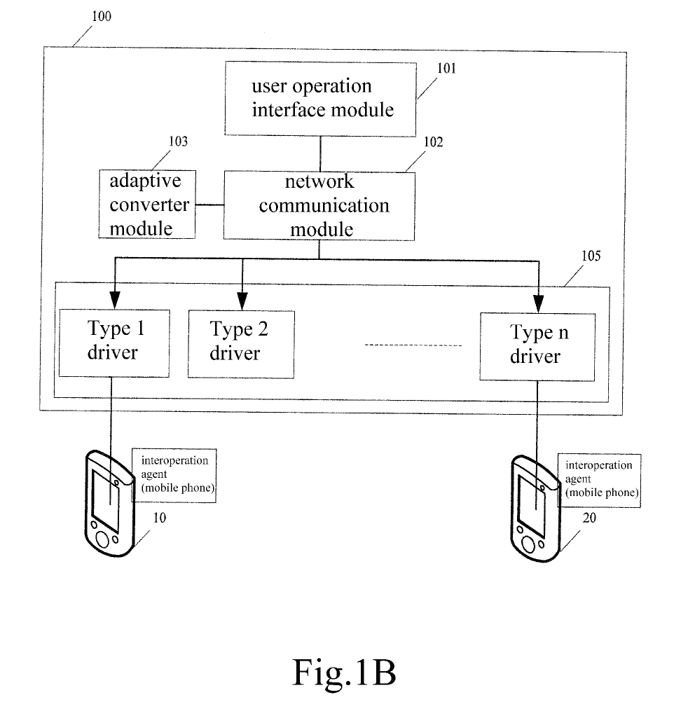

According to one of the embodiments, the system of the invention consists of 3 parts: mobile communication terminal device upon which is installed an agent for interoperation (such as a mobile phone), a PC upon which is installed an interoperation system (such as a laptop, a desktop computer, etc) and a server. FIG. 1 illustrates an indicative structure of the system for interoperation between the mobile phone and the PC based on a middleware. The system, as illustrated in FIG. 1, comprises three parts: mobile phone 10 and mobile phone 20 both installed with an agent for interoperation, the PC(not shown) installed with an interoperation system 100 and the server 200. Mobile phone 10 and mobile phone 20 are of different models, and the system of the invention is not limited to the mobile phones 10 and 20 as illustrated in FIG. 1, and other mobile phones in the market also apply to the present invention.

Mobile phone 10 and mobile phone 20 can be connected by a variety of physical means, such as Bluetooth, infrared, data cable, WLAN etc., the interoperation agent configured thereon receives requests from the interoperation system and performs corresponding tasks on the mobile phone on behalf of the interoperation system, comprising receiving files, sending files, starting a certain application, installing applications, etc.

The PC is installed with the interoperation system 100 mainly used for model adaptation and content adaptation. As an example, the interoperation system 100 mainly includes the following modules: a user operation interface module 101, an interoperation middleware 102, an adaptive converter module 103, a network communication module 104, and a driver module 105, and here below is the description of the function of each module:

User operation interface module 101: interfacing with the user through which operations are completed;

Interoperation middleware 102: shielding hardware difference between different mobile phones and provide unified interface for the user. Specifically, it utilizes different interfaces provided by different mobile phone drivers to realize the unified and consistent functions, such as establishing a connection, sending and receiving files, requesting format conversion, requesting network connection to download files, etc., so that it can provide unified functional interface for the user operation interface module 101, the adaptive converter module 103, and the network communication module 104.

Adaptive converter module 103: adaptively converting contents on the mobile phone between different formats, including format conversion, encoding conversion, etc., of video, audio, pictures, texts, etc.. This module can finish most of the adaptation, and when the adaptation requested by the user is not supported by this module, it passes the adaptation task on to the content adapter module of the server;

Network communication module 104: communicating with the server to cooperatively finish the request from the user;

Driver module 105: includes several types of drivers, for example, Type 1 driver, Type 2 driver . . . Type N driver, most of the mainstream mobile phone drivers are covered;

The server 200 is used for storing mobile phone driver and the corresponding mobile phone contents, including software, music, pictures, video, etc., and performing comprehensive content conversion. As an example, the server 200 mainly includes the following modules: a driver library 201, a content database 202, a content adapter module 203, a network communication module 204, etc., and here below is the description of the function of each module:

Driver library 201: a large number of mobile phone drivers are stored in the library, when the interoperation system cannot find a suitable driver in its own drivers, it connects to the server to search and download from this library;

Content database 202: abundant contents for mobile phones are stored in the database and the user can request to download these contents through the interoperation system;

Content adapter module 203: supporting various format conversions of mobile phone contents; when the adaptive converter module of the interoperation system is unable to complete requests from the user, it transmits the contents to the server via the internet, and the server will complete adaptation.

Network communication module 204: communicates with the PC to respond to network connection request from other modules.

The interoperation system 100 connects to the server 200 via the internet, searches for the suitable driver and mobile phone contents, requests the server 200 to perform content adaptation, etc.. The interoperation system 100 coordinates with the interoperation agent on the mobile phone to complete operations such as browsing of mobile files, bidirectional transmission of files, etc..

FIG. 1B provides a modification of the above embodiment of this invention. FIG. 1B illustrates another indicative structure of the system for interoperation between the mobile phone and the PC based on middleware, which comprises two parts: mobile phone 10 and mobile phone 20 both installed with the interoperation agent, and the PC (not shown) installed with the interoperation system 100. The same reference numbers are used for the same module in FIG. 1B and in the above embodiment. Mobile phone 10 and mobile phone 20 refer to different models, the system of the invention is not limited to the mobile phones 10 and 20, and other common mobile phones in the market also could be connected.

Mobile phone 10 and mobile phone 20 can be physically connected to the PC by multiple means, including Bluetooth, infrared, data cable, WLAN, etc. The PC is installed with the interoperation system 100 mainly to complete model adaptation and content adaptation. As an example, the interoperation system 100 mainly includes the following modules: user operation interface module 101, the interoperation middleware 102, the adaptive converter module 103, and a driver module 105. All the above modules have the same functions as those in FIG. 1A except that the network communication module 104 is not included within the interoperation system 100, and the detailed description will not be repeated hereby.

The interoperation system 100 coordinates with the interoperation agent within the mobile phone to complete operations such as browsing of mobile files, bidirectional transmission of files, etc..

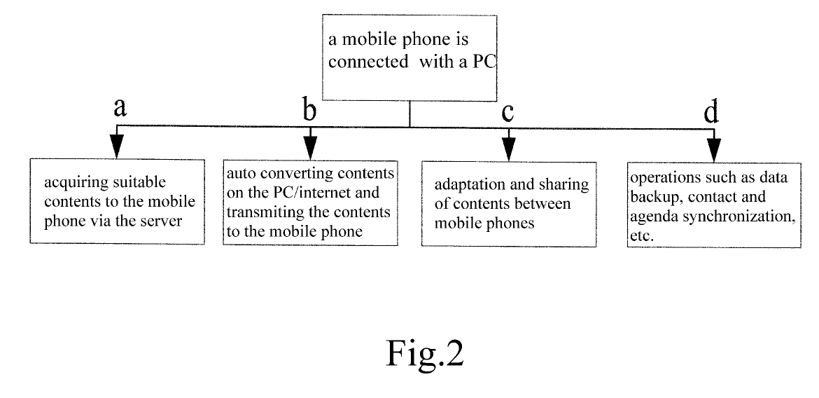

FIG. 2 illustrates the whole process of the present invention. First, the mobile phone is connected successfully with the PC, i.e. the interoperation agent is connected to the interoperation system. Then, the user can perform the following four kinds of operations: A, acquiring suitable contents to the mobile phone via the server; B automatically converting contents on the PC/internet and transmitting the contents to the mobile phone; C, adaptation and sharing of contents between mobile phones; D, operations such as data backup, contact and agenda synchronization, etc..

Here below is detailed description of the process and steps of the various methods claimed by the invention:

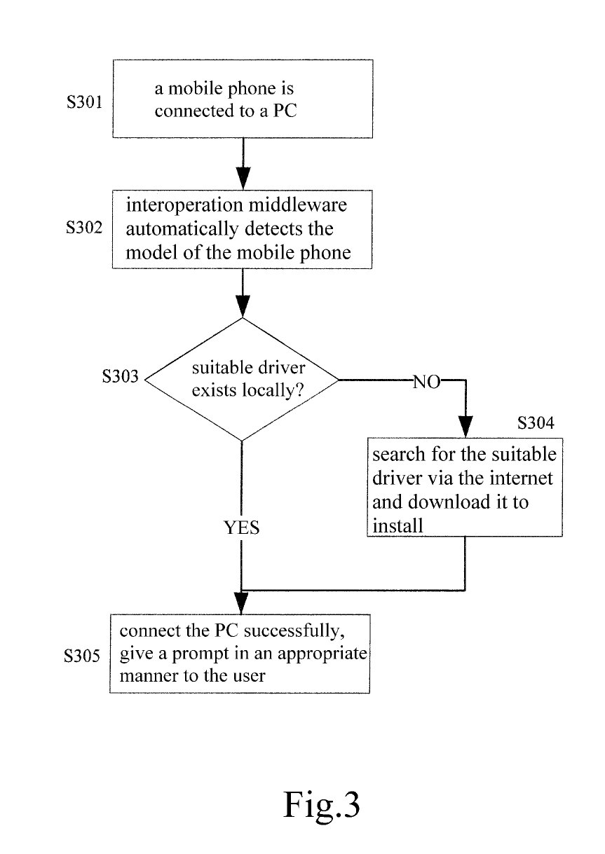

FIG. 3 illustrates the operation process of establishing connection between the PC and the mobile phone;

Step S301: the mobile phone is physically connected to the PC by Bluetooth, infrared, data cable, WLAN, etc.

Step S302: the interoperation system automatically detects the device model of the mobile phone that is connected to the PC;

Step S303: the interoperation system searches locally for a driver suitable for said model. When there is no such driver available, Step S304 is executed; when such driver is searched out, directly install it for use and Step S305 is executed.

Step S304: the interoperation system is connected to the server via the internet, searches for the suitable driver and downloads it to the local system to install.

Step S305: connecting the PC successfully with the mobile phone and give a prompt in an appropriate manner to the user on the PC. The user can complete operations via the user operation interface.

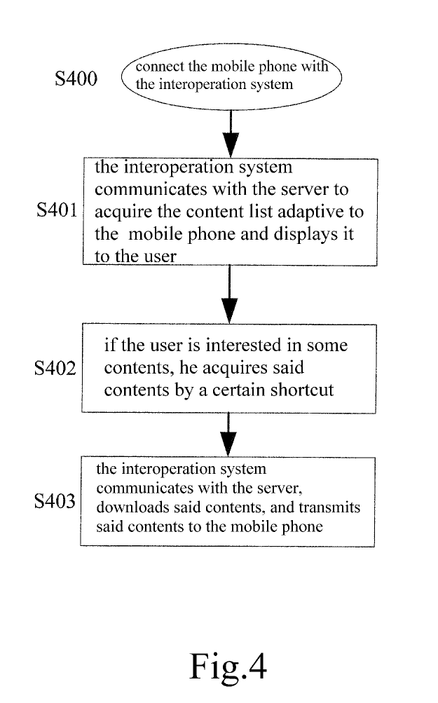

FIG. 4 illustrates the process of acquiring mobile phone contents from the server.

Step S400: establishing connection of the mobile phone with the interoperation system as shown in FIG. 3

Step S401: the interoperation system communicates with the server via internet to acquire the content list adaptive to the connected mobile phone and displays it to the user.

Step S402: if the user is interested in some contents, he may directly click the title of the contents or request to acquire said contents by a certain shortcut. The certain shortcut includes key combination, a certain item in the left or right click menu of the mouse, etc.. Optionally, the user may add the option “Download to the mobile phone” in the right click menu of IE, the specific operation of which is common means in the art and will not be described in detail hereby.

Step S403: the interoperation system communicates with the server, requests to download said contents on behalf of the user, and transmits said contents to the mobile phone.

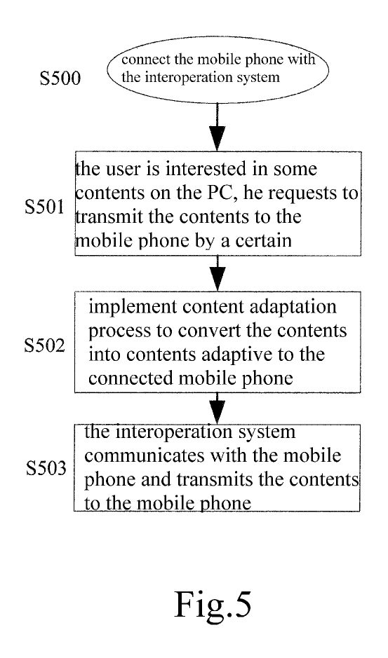

FIG. 5 illustrates the process in which the interoperation system automatically converts the contents on the PC and transmits them to the mobile phone.

Step S500: establishing connection of the mobile phone with the interoperation system as shown in FIG. 3.

Step S501: if the user is interested in some contents on the PC, he should firstly select the contents on the browser, and then requests to transmit the contents to the mobile phone by a certain shortcut. The certain shortcut includes key combination, a certain item in the left or right click menu of the mouse, etc.. Optionally, the user may add the option “Download to the phone” in the right click menu of IE.

Step S502: implement content adaptation process of the mobile phone to convert the contents into contents adaptive to the mobile phone.

Step S503: the interoperation system communicates with the mobile phone and transmits the converted contents to the mobile phone.

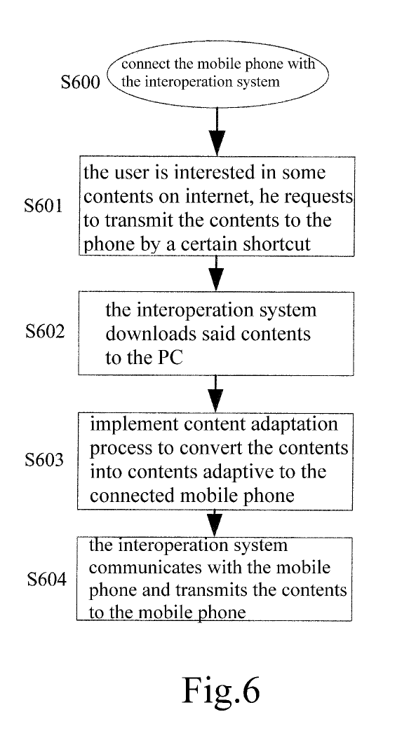

FIG. 6 illustrates the process in which the interoperation system automatically downloads and converts the contents on the internet and transmits them to mobile phone;

Step S600: connect the mobile phone with the interoperation system as shown in FIG. 3;

Step S601: if the user is interested in some contents on the internet, he should firstly select the contents on the Web browser, and then requests to transmit the contents to the mobile phone by a certain shortcut. The shortcut includes key combination, a certain item in the left or right click menu of the mouse, etc.. Optionally, the user may add the option “Download to the phone” in the right click menu of IE;

Step S602: the interoperation system downloads said contents to the PC;

Step S603: implement content adaptation process of the mobile phone to convert the contents into contents adaptive to the connected mobile phone;

Step S604: the interoperation system communicates with the mobile phone and transmits the adapted contents to the mobile phone.

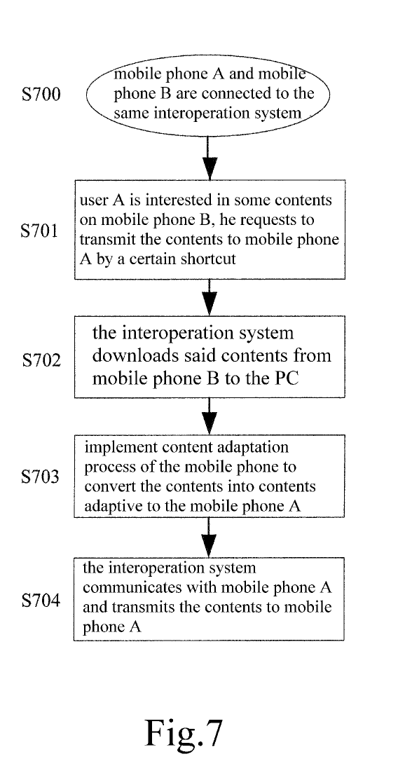

FIG. 7 illustrates the process of content adaptation and sharing between mobile phone A and mobile phone B via the interoperation system, wherein the mobile phone A and mobile phone B are indicative and may be of the same model or of different models. The process is premised on Step S700: mobile phone A and mobile phone B are successfully connected to the same interoperation system.

Step S701: when user A is interested in some contents on mobile phone B, he should firstly select said contents on the browser (including the system's own browser, browser of the interoperation system, etc.) and then requests to transmit said contents to mobile phone A by a certain shortcut. The shortcut includes key combination, a certain item in the left or right click menu of the mouse, etc..

Step S702: the interoperation system downloads said contents from mobile phone B to the PC.

Step S703: implement content adaptation process of the mobile phone to convert the contents into contents adaptive to the mobile phone A.

Step S704: the interoperation system communicates with mobile phone A and transmits the converted contents to mobile phone A.

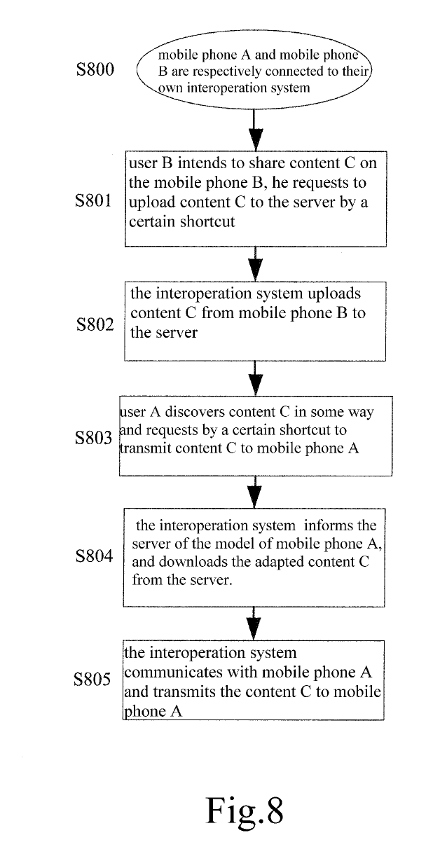

FIG. 8 illustrates the process of content adaptation and sharing between mobile phone A and mobile phone B via the server, wherein the mobile phone A and mobile phone B are indicative and may be of the same model or of different models. The process is premised on Step S800: mobile phone A and mobile phone B are respectively connected to their own interoperation system successfully.

Step S801: if user B intends to share content C on the mobile phone B with another user, he should request to upload content C to the server by a certain shortcut.

Step S802: the interoperation system which is successfully connected to mobile phone B uploads content C from mobile phone B to the server.

Step S803: user A discovers content C in some way and requests by a certain shortcut to transmit content C to mobile phone A.

Step S804: the interoperation system which is successfully connected to mobile phone A informs the server of the model of mobile phone A, the content adapter module of the server implements the process of content adaptation, and then the interoperation system downloads the adapted content C from the server.

Step S805: the interoperation system which is successfully connected to mobile phone A communicates with mobile phone A and transmits the adapted content C to mobile phone A.

As an example, step S804 may also be: the interoperation system which is successfully connected to mobile phone A downloads content C from the server and the content adapter module implements the content adaptation process of the mobile phone according to the model of the mobile phone A.

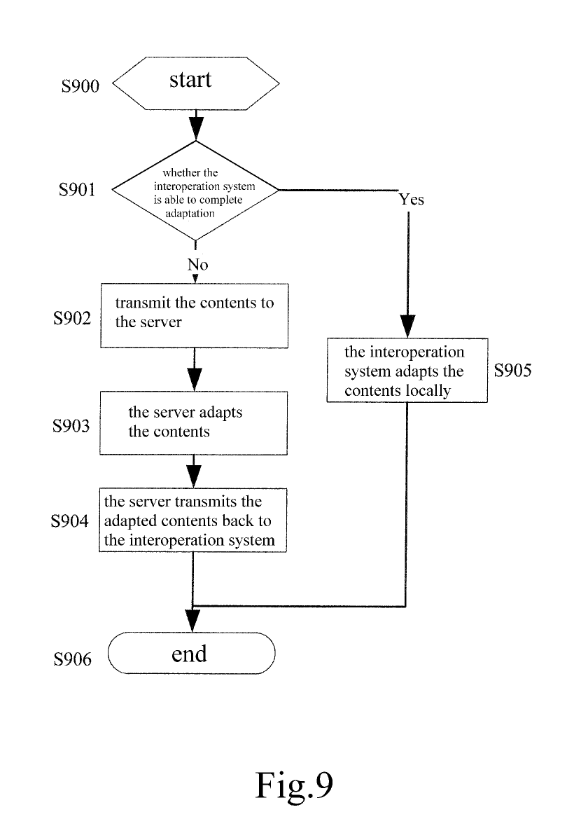

FIG. 9 illustrates the content adaptation process of the mobile phone

Step S900: Start.

Step S901: determine whether the interoperation system is able to complete content adaptation: if no, Step S902 is executed; if yes, Step S905 is executed.

Step S902: transmit the contents to be adapted to the server.

Step S903: the server adapts the received mobile phone contents.

Step S904: the server transmits the adapted mobile phone contents back to the interoperation system.

Step S905: the interoperation system adapts the mobile phone contents locally.

Step S906: end.

The above examples mainly illustrate the system and all application methods claimed by the present invention. Although only some of the modes for carrying out the invention are described hereby, it should be understand by the person skilled in the art that the invention can be carried out in many other modes without departing from the scope and spirit of the invention. Therefore, the examples and embodiments are deemed as indicative rather than restrictive. It is intended that the invention covers all such modifications and variations as fall within the true spirit and scope of the invention as defined in the appended claims.

What is claimed is:

1. A method for interoperation between a mobile phone and a PC based on a middleware, comprising the following steps:
connecting a first mobile phone to a first PC physically;
a first interoperation system installed within the first PC automatically detects the model of the first mobile phone that is connected to the first PC;
the first interoperation system searches in the local driver module of the first PC for a driver suitable for said model of the first mobile phone;
when such a driver is searched out, install it directly for use;
when no such driver is available, the first interoperation system is connected to the server via the internet, searches for a suitable driver, downloads it to the local system and installs it for use;
the first PC and the first mobile phone are connected successfully and there is a prompt of successful connection for the user of the first mobile phone.

2. The method as claimed in claim 1, further comprising the following steps after the first PC and the first mobile phone are connected successfully:
the first interoperation system communicates with the server via the network, acquires from the server the content list adaptive to the first connected mobile phone and displays it to the user of the first mobile phone;
the user requests to acquire contents of interest in the content list;
the first interoperation system communicates with the server and requests to download said contents on behalf of the user and transmits the downloaded contents to the first mobile phone.

3. The method as claimed in claim 1, further comprising the following steps after the first PC and the first mobile phone are connected successfully:
the user of the first mobile phone selects contents of interest from the file browser on the first PC and then requests to transmit said contents to the first mobile phone;
implements the adaptation process of the mobile phone contents to convert said contents into contents adaptive to the connected first mobile phone;
the first interoperation system communicates with the first mobile phone and transmits the converted contents into the mobile phone.

4. The method as claimed in claim 1, further comprising the following steps after the first PC and the first mobile phone are connected successfully:
the user of the first mobile phone selects contents of interest from the Web Browser on the first PC and then request to transmit said contents to the first mobile phone;
the first interoperation system downloads said contents onto the first PC;
implement the adaptation process of the mobile phone contents to convert said contents into contents adaptive to the connected first mobile phone;
the first interoperation system communicates with the first mobile phone and transmits the converted contents into the first mobile phone.

5. The method as claimed in claim 1, further comprising:
connecting a second mobile phone successfully with the first PC;
the user of the first mobile phone selects contents of interest on the second mobile phone via the browser and requests to transmit said contents to the first mobile phone;
the first interoperation system downloads said contents from the second mobile phone to the first PC;
implements the adaptation process of mobile phone contents to convert said downloaded contents to contents adaptive to the first mobile phone;
the first interoperation system communicates with the first mobile phone and transmits the converted contents to the first mobile phone.

6. The method as claimed in claim 1, further comprising:
connecting a second mobile phone successfully with a second PC;
the user of the second mobile phone requests to transmit contents of interest on the second phone to the server;
a second interoperation system in the second PC which is successfully connected to the second mobile phone uploads said contents from the second mobile phone to the server;
the user of the first mobile phone requests to transmit said contents to the first mobile phone;
the first interoperation system which is successfully connected to the first mobile phone informs the server of the model of the first mobile phone, the content adapter module of the server implements the content adaptation process of the mobile phone, and the first interoperation system downloads the contents adapted by the server;
the first interoperation system which is successfully connected to the first mobile phone communicates with the first mobile phone and transmits the adapted contents to the first mobile phone.

7. The method as claimed in claim 1, further comprising:
connecting the second mobile phone successfully to the second PC;
the user of the second mobile phone requests to upload the contents of interest on the second mobile phone to the server;
the second interoperation system on the second PC which is successfully connected to the second mobile phone uploads said contents from the second mobile phone to the server;
the user of the first mobile phone requests to transmit said contents to the first mobile phone;
the first interoperation system which is successfully connected to the first mobile phone downloads said contents from the server and implements the content adaptation process of the mobile phone based on the model of the first mobile phone;
the first interoperation system which is successfully connected to the first mobile phone communicates with the first mobile phone and transmits the adapted contents to the first mobile phone.

8. The method of any as claimed in any one of claims 3-7, wherein implementing the content adaptation process of the mobile phone further comprises:
determining whether the interoperation system is able to complete content adaptation;
when it is able to do so, the interoperation system completes content adaptation locally;
when it is unable to do so, the interoperation system uploads the contents to be adapted to the server; the server adapts the received mobile phone contents and then transmits the adapted contents back to the interoperation system.

9. The method of any as claimed in any one of claims 2-7, wherein the user makes a request using key combination, or the shortcut of a certain item of the right or left click menu of the mouse.

10. The method of any as claimed in any one of claims 1-7, wherein the first mobile phone and the second mobile phone can be either the same or different in model.

11. A system for interoperation between a mobile phone and a PC based on a middleware, comprising:
a mobile phone upon which is installed an interoperation agent;
a PC upon which is installed an interoperation system, wherein the interoperation system comprises: a user operation interface module, an interoperation middleware, an adaptive converter module and a driver module;
wherein said mobile phone is physically connected to said PC.

12. The interoperation system as claimed in claim 11, further comprising:
a server, wherein the server includes: a driver library, a content database, a content adapter module and a network communication module;
the PC installed with an interoperation system further includes a network communication module;
wherein the PC is physically connected to the server.

13. The interoperation system as claimed in claim 11 or claim 12, wherein the mobile phone is connected to the PC via any of the following means: Bluetooth, infrared, data cable, and WLAN, and the PC is connected to the server by internet.
